(19) United States
(12) Patent Application Publication
(10) Pub. No.: US 2026/0051543 A1
(43) Pub. Date: Feb. 19, 2026

(54) ELECTROLYTIC SOLUTION AND POWER STORAGE ELEMENT USING SAME

(71) Applicant: Panasonic Intellectual Property Management Co., Ltd., Osaka (JP)

(72) Inventors: Nobuyuki MATSUZAWA, TOKYO TO (JP); Keisuke HAYASHI, OSAKA FU (JP); Hiroyuki MAESHIMA, HYOGO KEN (JP); Yoshiaki OBANA, OSAKA FU (JP)

(21) Appl. No.: 19/101,850

(22) PCT Filed: Aug. 4, 2023
(86) PCT No.: PCT/JP2023/028582

§ 371 Date: Feb. 6, 2025

(30) Foreign Application Priority Data
Aug. 23, 2022 (JP) 2022-132663

(51) Int. Cl. H01M 10/0569; H01G 11/60; H01G 11/62; H01M 10/0525; H01M 10/0568

(52) U.S. Cl. CPC H01M 10/0569; H01G 11/60; H01G 11/62; H01M 10/0525; H01M 10/0568; H01M 2300/0037

(57) ABSTRACT

A power storage device is constituted using an electrolyte solution including a nonaqueous solvent, and an electrolyte dissolved in the nonaqueous solvent. The nonaqueous solvent contains a first compound having 11 or less heavy atoms and having one or more cyclopropane rings or aziridine rings. This can provide a power storage device that can exhibit excellent electrical characteristics with low resistance especially at low temperatures.

### TECHNICAL FIELD

The present disclosure relates to an electrolyte solution and a power storage device using the same.

### BACKGROUND ART

Power storage devices have been used in various applications. For example, electric double-layer capacitors and lithium-ion capacitors have been used as small power sources and the like for semiconductor memory backup and other applications. These capacitors are supposed to be used under harsh conditions. It is therefore important for the electrolyte solution used therein to have properties that enable the capacitor to operate stably for a long time over a wide temperature range from low to high temperatures. Patent Literature 1 discloses an electrolyte solution for electric double-layer capacitors, including: propylene carbonate as an organic solvent; and as an electrolyte, tetraethylammonium tetrafluoroborate, which is an aliphatic quaternary ammonium salt, dissolved therein.

Patent Literature 2 discloses an electrolyte solution for capacitors, including: a quaternary ammonium salt or a lithium salt as an electrolyte; and as an organic solvent, a mixed solvent containing acetonitrile. The acetonitrile has a low viscosity at room temperature, which is as low as 0.34 mPa's, and has a feature of being able to reduce the resistance value of the device, especially at low temperatures.

The above propylene carbonate and acetonitrile are also used in an electrolyte solution for nonaqueous liquid electrolyte secondary batteries.

### CITATION LIST

### Patent Literature

### Patent Literature 1: Japanese Laid-Open Patent Publication No. 2000-114105

Patent Literature 2: International Publication WO2013/146136

### SUMMARY OF INVENTION

### Technical Problem

However, with propylene carbonate, the viscosity of which at room temperature is slightly as high as 2.5 mPa's, the resistance value of the device is high especially at low temperatures. With acetonitrile, though the viscosity of which at room temperature is as low as 0.34 mPa's and which has a feature of being able to keep the resistance value of the device low especially at low temperatures, there is possibility of hydrocyanic acid gas to be generated due to combustion and the like in the event of an accident. The utilization thereof is therefore limited for safety reasons.

### Solution to Problem

One aspect of the present disclosure relates to an electrolyte solution, including a nonaqueous solvent, and an electrolyte dissolved in the nonaqueous solvent, wherein the nonaqueous solvent contains a first compound having 11 or less heavy atoms and having one or more cyclopropane rings or aziridine rings.

Another aspect of the present disclosure relates to a power storage device, including the above-described the electrolyte solution.

Yet another aspect of the present disclosure relates to a compound having any one of the following structures.

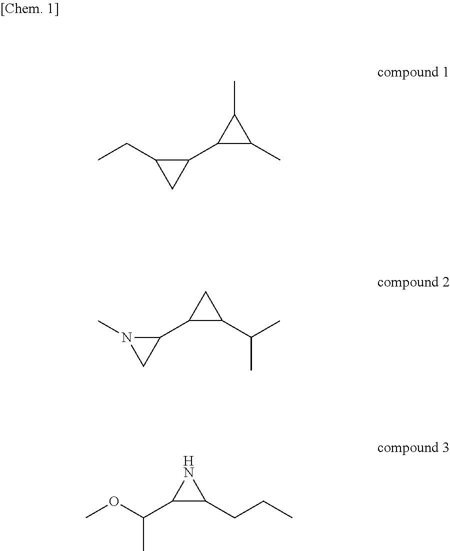

### Advantageous Effects of Invention

According to the electrolyte solution of the present disclosure, it is possible to provide a power storage device that can exhibit excellent electrical characteristics with low resistance especially at low temperatures.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A partially cutaway oblique view schematically illustrating the internal structure of a secondary battery according to an embodiment of the present disclosure.

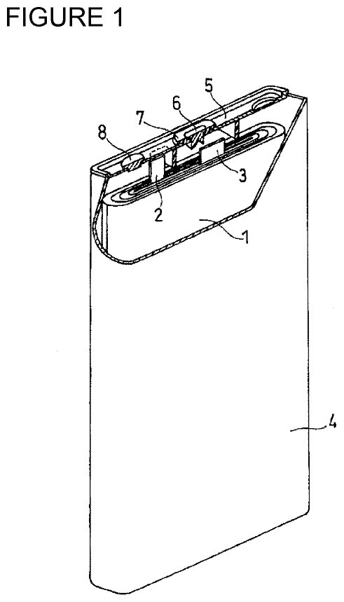

### DESCRIPTION OF EMBODIMENTS

Embodiments of an electrolyte solution and a power storage device according to the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The power storage device encompasses nonaqueous liquid electrolyte capacitors, nonaqueous liquid electrolyte secondary batteries, and the like. The power storage device may be a device that utilizes both the Faradaic reaction and the non-Faradaic reaction (i.e. having the properties of both capacitors and secondary batteries). Nonaqueous liquid electrolyte capacitors encompass electric double-layer capacitors, lithium-ion capacitors, and the like. Nonaqueous liquid electrolyte secondary batteries encompass lithium-ion secondary batteries and lithium-metal secondary batteries. The capacitor may also be referred to as a “condenser”.

The electrolyte solution according to one embodiment of the present disclosure is a nonaqueous electrolyte solution, and includes a nonaqueous solvent and an electrolyte dissolved in the nonaqueous solvent. The nonaqueous solvent may be an organic solvent. The nonaqueous solvent contains a first compound. The first compound is a compound having 11 or less heavy atoms and having one or more cyclopropane rings or aziridine rings. The first compound has a low viscosity, and the viscosity at room temperature can be 0.6 mPa's or less. Furthermore, the first compound, which contains no cyano group, will not generate toxic hydrocyanic acid gas even when combusted. By including the first compound in the nonaqueous solvent, it is possible to allow the power storage device to exert excellent electrical properties even at low temperatures. Specifically, safe nonaqueous liquid electrolyte capacitors, nonaqueous liquid electrolyte secondary batteries, and the like can be provided that have low internal resistance and excellent electrical conductivity and will not generate toxic gases when combusted.

Heavy atoms mean atoms other than hydrogen and helium atoms, and specific examples thereof include heteroatoms, such as nitrogen and oxygen atoms, and carbon atoms.

The first compound is preferably represented by one of compounds 1 to 3 having the following structures.

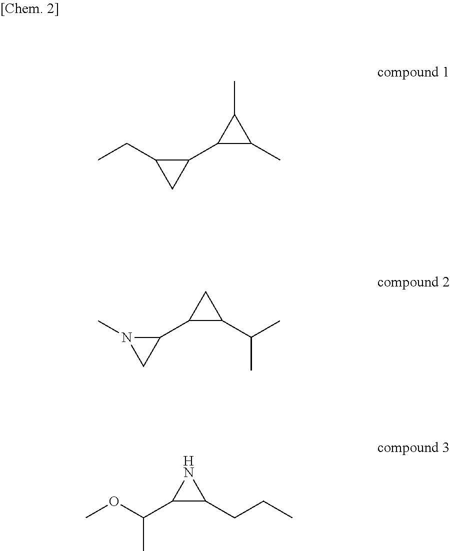

When the first compound is the compound 1, the compound 2, or the compound 3, the viscosity becomes further low, and the resistance of the power storage device at low temperatures can be further reduced.

One of the compounds 1 to 3 may be used singly, or two or more of the compounds 1 to 3 may be mixed and used.

The content of the first compound in the electrolyte solution is preferably 5 mass % or more and 80 mass % or less, may be 5 mass % or more and 50 mass % or less, and may be 5 mass % or more and 30 mass % or less. When the content of the first compound is 5 mass % or more, the viscosity of the whole mixed nonaqueous solvent is sufficiently reduced, leading to satisfactory improvement in the resistance at low temperatures. Conversely, when the content of the first compound is 80 mass % or less, the precipitation of the electrolyte (e.g., quaternary ammonium salt or lithium salt) is suppressed, leading to more favorable characteristics of the power storage device. The content of the first compound in the nonaqueous solvent may be 3 mass % or more and 50 mass % or less, may be 3 mass % or more and 30 mass % or less, and may be 3 mass % or more and 20 mass % or less.

The electrolyte solution of the present disclosure may be an electrolyte solution in which a quaternary ammonium salt or a lithium salt is dissolved in the nonaqueous solvent. With the nonaqueous solvent containing the first compound, the viscosity of the electrolyte solution becomes lower than when propylene carbonate is used. Therefore, the resistance of the power storage device at low temperatures is reduced. In addition, because of the absence of cyano groups in the molecular structure, there is no possibility of hydrogen cyanide gas being generated due to combustion in the event of an accident. The nonaqueous solvent may contain another compound in addition to the first compound. As another compound, a second compound selected from the group consisting of γ-butyrolactone, vinylene carbonate, propylene carbonate, ethylene carbonate, butylene carbonate, dimethyl carbonate, methyl ethyl carbonate, diethyl carbonate, and 3-methylsulfolane can be used.

The electrolyte in the electrolyte solution may be a quaternary ammonium salt or a lithium salt. The quaternary ammonium salt is desirably a salt composed of a tetraalkylammonium ion and an anion.

As the tetraalkylammonium ion, at least one of tetramethylammonium ion, trimethylethylammonium ion, triethylmethylammonium ion, tetraethylammonium ion, tetrabutylammonium ion, diethyldimethylammonium ion, ethyltrimethylammonium ion, and the like can be used.

Examples of the anions constituting the quaternary ammonium salt or lithium salt include Cl⁻, BF₄⁻, PF₆⁻, CICO₄⁻, CF₃SO₃⁻, N (FSO₂)₂⁻, N(CF₃SO₂)₂⁻, N(C₂F₅SO₂)₂⁻, and

C (CF₃SO₂)₃⁻.

Preferred as the quaternary ammonium salt is triethylmethylammonium tetrafluoroborate. Preferred as the lithium salt is LiPF₆.

A preferred lower limit of the concentration of the quaternary ammonium salt or the lithium salt in the electrolyte solution of the present disclosure is 0.1 mol/L, and a preferred upper limit thereof is 3.0 mol/L. When the concentration of the quaternary ammonium salt or the lithium salt is 0.1 mol/L or more, sufficient electrical conductivity can be ensured. When the concentration of the quaternary ammonium salt or the lithium salt is 3.0 mol/L or less, the increase in the viscosity of the resulting electrolyte solution can be suppressed, and a power storage device with excellent electrical properties can be obtained. A more preferred lower limit of the concentration of the quaternary ammonium salt or lithium salt is 0.5 mol/L, and a more preferred upper limit thereof is 2 mol/L.

The method for producing an electrolyte solution of the present invention is as described below. First, a nonaqueous solvent and a quaternary ammonium salt or a lithium salt are dehydrated. Then, in a low-humidity environment, such as a glove box, an electrolyte composed of the quaternary ammonium salt or the lithium salt is added to a nonaqueous solvent, and dissolved.

The present invention also encompasses a power storage device using the electrolyte solution prepared here. For example, an electric double-layer capacitor includes a pair of polarizable electrodes, a separator interposed between the electrodes, the electrolyte solution, and a container for sealing them. A lithium-ion capacitor includes a polarizable positive electrode, a negative electrode capable of absorbing and releasing lithium ions, the electrolyte solution, a separator interposed between the electrodes, and a container for containing them. A lithium-ion secondary battery includes a positive electrode capable of absorbing and releasing lithium ions, a negative electrode capable of absorbing and releasing lithium ions, the electrolyte solution, a separator interposed between the electrodes, and a container for containing them.

The structure of a nonaqueous electrolyte secondary battery as an example of the power storage device will be described below, with reference to Figure. Figure is a partially-cutaway schematic oblique view of a prismatic nonaqueous liquid secondary battery.

The secondary battery includes a bottomed prismatic battery case 4, an electrode group 1 and a nonaqueous electrolyte (not shown) housed in the battery case 4. The electrode group 1 includes a long negative electrode, a long positive electrode, and a separator interposed therebetween. The electrode group 1 is formed by winding the negative electrode, the positive electrode, and the separator around a flat winding core, and removing the winding core.

To the negative electrode current collector of the negative electrode, a negative electrode lead 3 is attached at its one end by welding or the like. To the positive electrode current collector of the positive electrode, a positive electrode lead 2 is attached at its one end by welding or the like. The other end of the negative electrode lead 3 is electrically connected to a negative electrode terminal 6 which is provided at a sealing plate 5 with a gasket 7 interposed therebetween. The other end of the positive electrode lead 2 is electrically connected to the battery case 4 serving as a positive electrode terminal. On top of the electrode group 1, a resin frame body providing separation between the electrode group 1 and the sealing plate 5 and providing separation between the negative electrode lead 3 and the battery case 4 is disposed. The opening of the battery case 4 is sealed with the sealing plate 5.

The present disclosure includes, as another embodiment, a compound having a structure of any one of the following compounds 1 to 3.

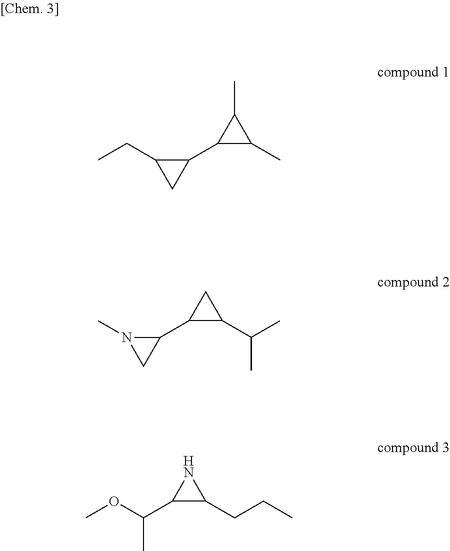

As yet another embodiment, an electrolyte solution additive having a structure of any one of the following compounds 1 to 3 is included.

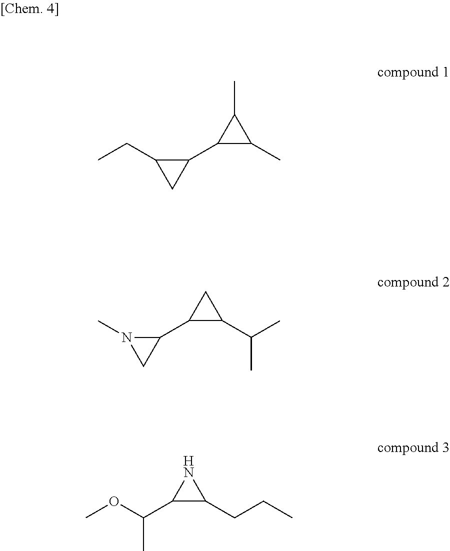

### EXAMPLES

The present disclosure will be specifically described below by way of Examples and Comparative Examples. The present disclosure, however, is not limited to the following Examples.

### Method for producing compound 1

The compound 1 is synthesized by generating an intermediate 1 from one of two kinds of bromocyclopropane compounds, using a Grignard reagent, followed by the Grignard reaction between the intermediate 1 and the other bromocyclopropane compound.

In an inert gas atmosphere, to a mixture of metallic magnesium (26.9 g, 1.11 mol) and THF (500 mL), 1-bromo-2-ethylcyclopropane (150 g, 1.01 mol) dissolved in THF (500 mL) was added dropwise over 30 minutes, and stirred at room temperature for 5 hours, to prepare a Grignard reagent. The Grignard reagent was added dropwise over 30 minutes to a 1-bromo-2,3-dimethylcyclopropane (165 g, 1.11 mol)-and-THF (500 mL) mixture which has been cooled to −70° C. The mixture was warmed to room temperature, and stirred for 8 hours. The reaction solution was quenched with water. Then, the organic layer extracted with ethyl acetate was washed with saturated saline solution, then dried with anhydrous sodium sulfate, and the solvent was distilled off under reduced pressure. The obtained liquid was purified by silica gel column chromatography (petroleum ether/ethyl acetate). Thus, a compound 1 (97.7 g, 0.707 mol) was obtained in a 70% yield.

### Method of Producing Compound 2

The compound 2 is synthesized by a two-stage reaction including cyclopropane ring formation through the Simmons-Smith reaction and aziridine ring formation through an intramolecular cyclization reaction.

(Cyclopropane ring formation through Simmons-Smith reaction)

In an inert gas atmosphere, 1M diethylzinc/hexane solution (500 mL, 0.500 mol) and dichloromethane (1000 mL) were mixed, and cooled to 0° C. Then, 5M trifluoroacetic acid/dichloromethane solution (100 mL, 0.500 mol) was added dropwise thereto over 30 minutes, and stirred for 1 hour. While the reaction solution was maintained at 0° C., 1,1-diiodo-2-methylpropane (155 g, 0.500 mol) dissolved in dichloromethane (500 mL) was added thereto dropwise over 30 minutes, and 1-(methylamino)-3-buten-2-ol (101 g, 1.00 mol) dissolved in dichloromethane (1000 mL) was further added dropwise over 30 minutes, and then, stirred at room temperature for 12 hours. The reaction solution was quenched with 0.1 M aqueous ammonium chloride solution. Then, the organic layer extracted with ethyl acetate was washed with saturated saline solution, then dried with anhydrous sodium sulfate, and the solvent was distilled off under reduced pressure. The obtained mixture was purified by silica gel column chromatography (petroleum ether/ethyl acetate). Thus, 2-isopropyl-α-[(methylamino) methyl]cyclopropanemethanol (59.0 g, 0.375 mol) was obtained in a yield of 75%.

(Aziridine ring formation through intramolecular cyclization reaction)

To a mixed solution of benzene (300 mL) and 2-isopropyl-α-[(methylamino) methyl]cyclopropanemethanol (80.0 g, 0.509 mol), paratoluenesulfonyl chloride (116 g, 0.610 mol) and tetrabutylammonium hydrogen sulfate (34.6 g, 0.102 mol) dissolved in benzene (200 mL) were added, and stirred for 30 minutes. Then, 50% aqueous sodium hydroxide solution (50 mL) was added thereto, and stirred at room temperature for 2 hours. Upon completion of the reaction, the organic layer was separated, and the aqueous layer was extracted three times with ethyl acetate. The organic layers all together were washed twice with water and twice with saturated saline solution, then dried with anhydrous sodium sulfate, and the solvent was distilled off under reduced pressure. The obtained mixture was purified by column chromatography (pentane/ethanol) using silica gel inactivated with triethylamine. Thus, a compound 2 (49.6 g, 0.356 mol) was obtained in a yield of 70%.

### Method for Producing Compound 3

The compound 3 is synthesized by a three-stage reaction including aldehyde formation through the Dess-Martin reaction, alkyl adduct formation through the Grignard reaction, and aziridine ring formation through an intramolecular cyclization reaction.

(Aldehyde formation through Dess-Martin reaction)

To a mixed solution of dichloromethane (2000 mL) and 2-amino-3-methoxybutan-1-ol (71.5 g, 0.600 mol), Dess-Martin periodinane (331 g, 0.780 mol) was added, and stirred at room temperature for 2 days. The reaction solution was quenched with methanol, and stirred for 1 hour. The resulting suspension was filtered, and the filtrate was distilled under reduced pressure to remove the solvent. The obtained mixture was purified by silica gel column chromatography (pentane/ethyl acetate). Thus, 2-amino-3-methoxybutanal (47.8 g, 0.408 mol) was obtained in a yield of 63%.

(Alkyl adduct formation through Grignard reaction)

A mixed solution of THF (700 mL) and 2-amino-3-methoxybutanal (82.0 g, 0.700 mol) was cooled to −70° C., and then, 2M propylmagnesium bromide/THF solution (700 mL, 1.40 mol) was added dropwise thereto over 30 minutes. The mixture was warmed to room temperature, and stirred for 8 hours. After the reaction solution was quenched with water, the organic layer extracted with ethyl acetate was washed with saturated saline solution, then dried with anhydrous sodium sulfate, and the solvent was distilled off under reduced pressure. The obtained liquid was purified by silica gel column chromatography (petroleum ether/ethyl acetate). Thus, 3-amino-2-methoxyheptan-4-ol (57.6 g, 0.357 mol) was obtained in a yield of 51%.

(Aziridine ring formation through intramolecular cyclization reaction)

To a mixed solution of THF (1500 mL) and triphenylphosphine (127 g, 0.484 mol), diisopropyl azodicarboxylate (93.0 mL, 0.484 mol) was added dropwise, and stirred at room temperature for 30 minutes. To the resultant mixed solution, a mixed solution of THF (2000 mL) and 3-amino-2-methoxyheptan-4-ol (65.0 g, 0.403 mol) was added dropwise, and heated under reflux for 24 hours. After the reaction solution was cooled to room temperature, the solvent was distilled off under reduced pressure. Diethyl ether was added to the obtained mixture, the precipitate was filtered, and the filtrate was distilled under reduced pressure to remove the solvent. The obtained mixture was purified by column chromatography (pentane/ethanol) using silica gel inactivated with triethylamine. Thus, a compound 3 (41.6 g, 0.209 mol) was obtained in a yield of 72%.

(Viscosity measurement)

The viscosities at room temperature of the compounds 1 to 3 synthesized as above were measured using a viscometer RSM-MV1 available from SMILECo. The viscosities were 0.46 mPa's in the compound 1, 0.52 mPa's in the compound 2, and 0.58 mPa's in the compound 3, all of which were 0.6 mPa's or less. These values are lower than 2.5 mPa's which is the viscosity of propylene carbonate commonly used as a solvent for electrolyte solution. Also, diethyl carbonate and dimethyl carbonate are also often used as a low viscous solvent, the viscosities of which, however, are respectively 0.8 mPa's and 0.6 mPa's, and the above viscosities are lower than these.

### Comparative Example 1

Triethylmethylammonium tetrafluoroborate was added at a concentration of 1.0 mol/L to propylene carbonate, to obtain an electrolyte solution for capacitors.

### Comparative Example 2

Triethylmethylammonium tetrafluoroborate was added at a concentration of 1.0 mol/L to a mixed solvent of 90 parts by weight of propylene carbonate (Tokyo Chemical Industry Co., Ltd.) and 10 parts by weight of dibutyl carbonate (Tokyo Chemical Industry Co., Ltd.), to obtain an electrolyte solution for capacitors.

### Comparative Example 3

Triethylmethylammonium tetrafluoroborate was added at a concentration of 1.0 mol/L to a mixed solvent of 90 parts by weight of propylene carbonate (Tokyo Chemical Industry Co., Ltd.) and 10 parts by weight of pimelic acid (Tokyo Chemical Industry Co., Ltd.), to obtain an electrolyte solution for capacitors.

### Example 1

Triethylmethylammonium tetrafluoroborate was added at a concentration of 1.0 mol/L to a mixed solvent of 90 parts by weight of propylene carbonate (Tokyo Chemical Industry Co., Ltd.) and 10 parts by weight of the compound 1, to obtain an electrolyte solution for capacitors.

### Example 2

Triethylmethylammonium tetrafluoroborate was added at a concentration of 1.0 mol/L to a mixed solvent of 90 parts by weight of propylene carbonate (Tokyo Chemical Industry Co., Ltd.) and 10 parts by weight of the compound 2, to obtain an electrolyte solution for capacitors.

### Example 3

Triethylmethylammonium tetrafluoroborate was added at a concentration of 1.0 mol/L to a mixed solvent of 90 parts by weight of propylene carbonate (Tokyo Chemical Industry Co., Ltd.) and 10 parts by weight of the compound 3, to obtain an electrolyte solution for capacitors.

### Preparation of Laminated Cell

An aluminum sheet of 30 mm wide and 20 μm thick was prepared as a current collector, and activated carbon was applied onto both sides of the current collector, each in a thickness of 80 μm, to form an electrode. The electrode was then cut into a size of 20×72 mm, and an electrode lead was welded to the surface of aluminum of the current collector. A 50-μm-thick separator made of cellulose was sandwiched with a pair of the electrodes, and housed in a container made of aluminum laminated film, into which the electrolyte solution was injected in a dry chamber, so that the electrodes were impregnated therewith. The container was then sealed, to complete a laminated cell of a capacitor.

### Measurement of Internal Resistance

A voltage of 3.0 V was applied to the produced capacitor, and the internal resistance thereof was measured at −30° C.

The measured internal resistance value at 30° C. of each laminated cell is shown in Table 1 as a relative value to the internal resistance value of Comparative Example 1.

TABLE 1

| | relative value to Com. Ex. 1 |
|---|---|
| Com. Ex. 1 | 1.0 |
| Com. Ex. 2 | 1.8 |
| Com. Ex. 3 | 1.5 |
| Ex. 1 | 0.85 |
| Ex. 2 | 0.93 |
| Ex. 3 | 0.93 |

Table 1 show that, in Examples 1 to 3 in which a compound having 11 or less heavy atoms and having one or more cyclopropane rings or aziridine rings was used, the internal resistance values were lower than that of Comparative Example 1 in which only propylene carbonate was used.

Moreover, as did in Comparative Example 2, when a compound having 12 heavy atoms was used, the internal resistance value was increased to be higher than that of Comparative Example 1. Furthermore, as shown in Comparative Example 3, even when the number of heavy atoms was 11 or less, without cyclopropane ring or aziridine ring, the internal resistance value was increased.

### Production of Secondary Battery

(Negative electrode)

A negative electrode active material (graphite), sodium carboxymethylcellulose (CMC-Na), and styrene-butadiene rubber (SBR) were mixed in a mass ratio of 97.5:1:1.5, and water was added thereto. The mixture was stirred using a mixer (T.K. HIVIS MIX, available from PRIMIX Corporation), to prepare a negative electrode mixture slurry. Next, the negative electrode mixture slurry was applied onto a surface of a copper foil, so that the mass of the negative electrode mixture per 1 m² was 190 g. The applied film was dried, and then rolled, to give a negative electrode with a negative electrode mixture layer having a density of 1.5 g/cm³ formed on each of both sides of the copper foil.

(Positive electrode)

A lithium-nickel composite oxide (LiNi_{0.8}Co_{0.18}Al_{0.02}O₂), acetylene black, and polyvinylidene fluoride were mixed in a mass ratio of 95:2.5:2.5, and N-methyl-2-pyrrolidone (NMP) was added thereto. The mixture was stirred using a mixer (T.K. HIVIS MIX, available from PRIMIX Corporation), to prepare a positive electrode mixture slurry. Next, the positive electrode mixture slurry was applied onto a surface of an aluminum foil. The applied film was dried, and then rolled, to give a positive electrode with a positive electrode mixture layer having a density of 3.6 g/cm³ formed on each of both sides of the aluminum foil.

### Comparative Example 4

Ethylene carbonate (EC), dimethyl carbonate (DMC), and ethyl methyl carbonate (EMC) were mixed in a volume ratio of 20:70:10, to prepare a nonaqueous electrolyte solution. The lithium salt used here was LiPF₆. The concentration of LiPF₆ in the electrolyte solution was 1.2 mol/L.

### Comparative Example 5

Ethylene carbonate (EC), dimethyl carbonate (DMC), ethyl methyl carbonate (EMC), and dibutyl carbonate (Tokyo Chemical Industry Co., Ltd.) were mixed in a volume ratio of 18:63:9:10, to prepare a nonaqueous electrolyte solution. The lithium salt used here was LiPF₆. The concentration of LiPF₆ in the electrolyte solution was 1.2 mol/L.

### Comparative Example 6

Ethylene carbonate (EC), dimethyl carbonate (DMC), ethyl methyl carbonate (EMC), and pimelic acid (Tokyo Chemical Industry Co., Ltd.) were mixed in a volume ratio of 18:63:9:10, to prepare a nonaqueous electrolyte solution. The lithium salt used here was LiPF₆. The concentration of LiPF₆ in the electrolyte solution was 1.2 mol/L.

### Example 4

Ethylene carbonate (EC), dimethyl carbonate (DMC), ethyl methyl carbonate (EMC), and the compound 1 were mixed in a volume ratio of 18:63:9:10, to prepare a nonaqueous electrolyte solution. The lithium salt used here was LiPF₆. The concentration of LiPF₆ in the electrolyte solution was 1.2 mol/L.

### Example 5

Ethylene carbonate (EC), dimethyl carbonate (DMC), ethyl methyl carbonate (EMC), and the compound 2 were mixed in a volume ratio of 18:63:9:10, to prepare a nonaqueous electrolyte solution. The lithium salt used here was LiPF₆. The concentration of LiPF₆ in the electrolyte solution was 1.2 mol/L.

### Example 6

Ethylene carbonate (EC), dimethyl carbonate (DMC), ethyl methyl carbonate (EMC), and the compound 3 were mixed in a volume ratio of 18:63:9:10, to prepare a nonaqueous electrolyte solution. The lithium salt used here was LiPF₆. The concentration of LiPF₆ in the electrolyte solution was 1.2 mol/L.

The positive electrode and the negative electrode, with a tab attached to each electrode, were wound spirally with a separator interposed therebetween such that the tabs were positioned at the outermost layer, thereby to form an electrode group. The electrode group was inserted into an outer body made of aluminum laminated film, and dried under vacuum at 105° C. for 2 hours. The nonaqueous electrolyte solution was injected thereinto, and the opening of the outer body was sealed, to complete a secondary battery.

<Measurement of discharge capacity (battery capacity)>

The secondary battery produced as above was subjected, in a−5° C. environment, to a constant-current charging at a constant current of 0.3 It (800 mA) until the voltage reached 4.2 V, and then, to a constant-voltage charging at a constant voltage of 4.2 V until the current reached 0.015 It (40 mA). This was followed by a constant-current discharging performed at a current of 0.3 It (800 mA) until the voltage reached 2.75 V. The discharge capacity at this time was determined as a battery capacity.

The battery capacity at −5° C. of each secondary battery measured in this way is shown in Table 2 as a relative value to the battery capacity of Comparative Example 4.

TABLE 2

| | relative value to Com. Ex. 1 |
|---|---|
| Com. Ex. 4 | 1.0 |
| Com. Ex. 5 | 0.6 |
| Com. Ex. 6 | 0.8 |
| Ex. 4 | 1.2 |
| Ex. 5 | 1.1 |
| Ex. 6 | 1.1 |

Table 2 shows that, in Examples 4 to 6 in which a compound having 11 or less heavy atoms and having one or more cyclopropane rings or aziridine rings was used, the battery capacity was higher than that in Comparative Example 4 in which an electrolyte solution not containing such a compound was used. Moreover, as did in Comparative Example 5, when a compound having 12 heavy atoms was used, the battery capacity was decreased to be lower than that of Comparative Example 4. Furthermore, as shown in Comparative Example 6, even when the number of heavy atoms was 11 or less, without cyclopropane ring or aziridine ring, the battery capacity was decreased.

The foregoing shows that, by using an electrolyte solution material according to the present disclosure, the internal resistance of the device can be reduced, and it is possible to improve the operating characteristics at low temperatures.

### Supplementary Notes

The above description of embodiments discloses the following techniques.

### (Technique 1)

An electrolyte solution, comprising
a nonaqueous solvent, and an electrolyte dissolved in the nonaqueous solvent, wherein
the nonaqueous solvent contains a first compound having 11 or less heavy atoms and having one or more cyclopropane rings or aziridine rings.

### (Technique 2)

The electrolyte solution according to technique 1, wherein the first compound is one of the following compounds 1 to 3.

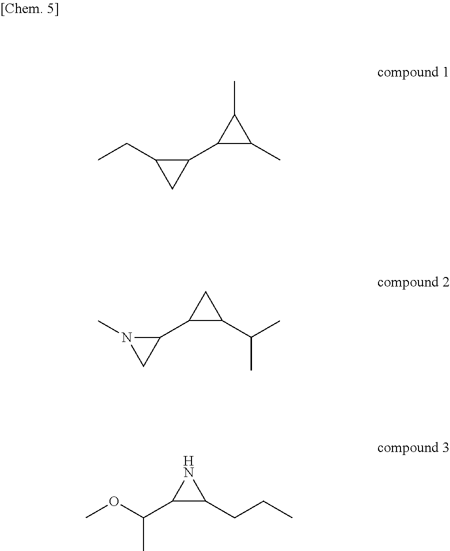

### (Technique 3)

The electrolyte solution according to technique 1 or 2, wherein a content of the first compound is 5 mass % or more and 80 mass % or less.

### (Technique 4)

The electrolyte solution according to any one of techniques 1 to 3, wherein the nonaqueous solvent further contains a second compound selected from the group consisting of y-butyrolactone, vinylene carbonate, propylene carbonate, ethylene carbonate, butylene carbonate, dimethyl carbonate, methyl ethyl carbonate, diethyl carbonate, and 3-methylsulfolane.

### (Technique 5)

The electrolyte solution according to any one of techniques 1 to 4, wherein the electrolyte includes a quatemary ammonium salt or a lithium salt.

### (Technique 6)

The electrolyte solution according to technique 5, wherein the quatemary ammonium salt includes a salt composed of a tetraalkylammonium ion and an anion.

### (Technique 7)

The electrolyte solution according to technique 6, wherein the tetraalkylammonium ion includes at least one selected from the group consisting of tetramethylammonium ion, trimethylethylammonium ion, triethylmethylammonium ion, tetraethylammonium ion, tetrabutylammonium ion, and diethyldimethylammonium ion.

### (Technique 8)

The electrolyte solution according to technique 6 or 7, wherein the anion incudes an anion selected from the group consisting of Cl⁻, BF₄⁻, PF₆⁻, CICO₄⁻, CF₃SO₃⁻, N (FSO₂)₂⁻, N(CF₃SO₂)₂⁻, N(C₂F₅SO₂)₂⁻, and C (CF₃SO₂)₃⁻.

### (Technique 9)

The electrolyte solution according to technique 5, wherein
the quaternary ammonium salt is triethylmethylammonium tetrafluoroborate, and
the lithium salt is LiPF₆.

### (Technique 10)

The electrolyte solution according to technique 5, wherein a content of the quaternary ammonium salt or the lithium salt in the electrolyte solution is 0.1 mol/L or more and 3.0 mol/L or less.

### (Technique 11)

The electrolyte solution according to technique 5, wherein a content of the quaternary ammonium salt or the lithium salt in the electrolyte solution is 0.5 mol/L or more and 2.0 mol/L or less.

### (Technique 12)

A power storage device, comprising the electrolyte solution according to any one of techniques 1 to 11.

### (Technique 13)

A compound having a structure of any one of the following compounds 1 to 3.

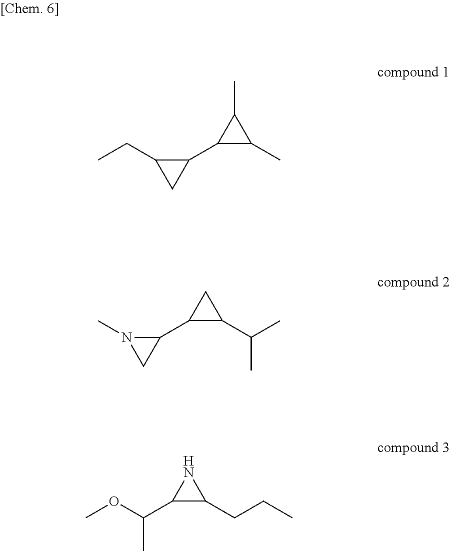

### (Technique 14)

An electrolyte solution additive having a structure of any one of the following compounds 1 to 3.

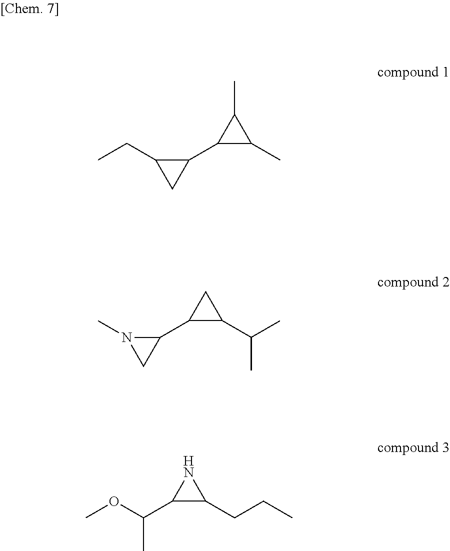

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The electrolyte solution according to the present disclosure is applicable to power storage devices, such as nonaqueous liquid electrolyte capacitors and nonaqueous liquid electrolyte secondary batteries. The power storage device according to the present disclosure is useful as a main power source for mobile communication equipment, portable electronic equipment, and the like.

### REFERENCE SIGNS LIST

1 electrode group
2 positive electrode lead
3 negative electrode lead
4 battery case
5 sealing plate
6 negative electrode terminal
7 gasket

1. An electrolyte solution, comprising
a nonaqueous solvent, and an electrolyte dissolved in the nonaqueous solvent, wherein
the nonaqueous solvent contains a first compound having 11 or less heavy atoms and having one or more cyclopropane rings or aziridine rings.

2. The electrolyte solution according to claim 1, wherein the first compound is one of the following compounds 1 to 3.

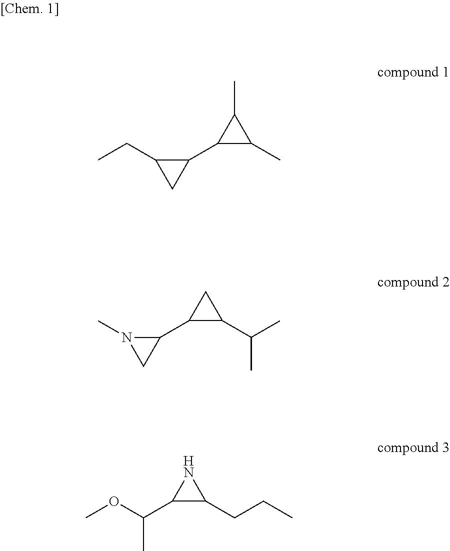

3. The electrolyte solution according to claim 1, wherein a content of the first compound is 5 mass % or more and 80 mass % or less.

4. The electrolyte solution according to claim 1, wherein the nonaqueous solvent further contains a second compound selected from the group consisting of γ-butyrolactone, vinylene carbonate, propylene carbonate, ethylene carbonate, butylene carbonate, dimethyl carbonate, methyl ethyl carbonate, diethyl carbonate, and 3-methylsulfolane.

5. The electrolyte solution according to claim 1, wherein the electrolyte includes a quaternary ammonium salt or a lithium salt.

6. The electrolyte solution according to claim 5, wherein the quaternary ammonium salt includes a salt composed of a tetraalkylammonium ion and an anion.

7. The electrolyte solution according to claim 6, wherein the tetraalkylammonium ion includes at least one selected from the group consisting of tetramethylammonium ion, trimethylethylammonium ion, triethylmethylammonium ion, tetraethylammonium ion, tetrabutylammonium ion, and diethyldimethylammonium ion.

8. The electrolyte solution according to claim 6, wherein the anion incudes an anion selected from the group consisting of Cl⁻, BF₄⁻, PF₆⁻, ClO₄⁻, CF₃SO₃⁻, N(FSO₂)₂⁻, N(CF₃SO₂)₂⁻, N(C₂F₅SO₂)₂⁻, and C (CF₃SO₂)₃⁻.

9. The electrolyte solution according to claim 5, wherein
the quaternary ammonium salt is triethylmethylammonium tetrafluoroborate, and the lithium salt is LiPF₆.

10. The electrolyte solution according to claim 5, wherein a content of the quaternary ammonium salt or the lithium salt in the electrolyte solution is 0.1 mol/L or more and 3.0 mol/L or less.

11. The electrolyte solution according to claim 5, wherein a content of the quaternary ammonium salt or the lithium salt in the electrolyte solution is 0.5 mol/L or more and 2.0 mol/L or less.

12. A power storage device, comprising the electrolyte solution according to claim 1.

13. A compound having a structure of any one of the following compounds 1 to 3. [chemical structure]
